(19) United States
(12) Patent Application Publication
(10) Pub. No.: US 2013/0334108 A1
(43) Pub. Date: Dec. 19, 2013

(54) CENTRIFUGAL SIFTING APPARATUS

(71) Applicant: Kek-Gardner Limited, Macclesfield (GB)

(72) Inventors: George TUNNICLIFFE, Congleton (GB); Steven Paul BAYLEY, Macclesfield (GB)

(21) Appl. No.: 13/921,888

(22) Filed: Jun. 19, 2013

(30) Foreign Application Priority Data
Jun. 19, 2012 (GB) 1210849.4

(51) Int. Cl. B07B 1/06

(52) U.S. Cl. CPC B07B 1/06
USPC 209/240; 209/247

(57) ABSTRACT

A stationary screen (14) of cylindrical or frusto-conical form is mounted inside the downstream end sifting section (10B) of a machine housing (10) which also has an upstream end feed section (10A). An auger screw (24) is provided in the upstream end section (10A) on a shaft (20) which is rotatable so as to feed material to be sifted into an end of the screen (14). The shaft (20) is mounted in cantilever manner from the upstream end of the housing (10) and drive means are mounted at or near the upstream end of the housing to rotate the shaft (20). A paddle assembly (26) is provided in the downstream end section (10B), inside the screen (14), and is mounted to the same shaft (20) as the auger screw (24). This shaft (20) is a hollow shaft. A second rotatable shaft (30) extends, preferably co-axially, through the first hollow shaft (20) and projects beyond the first hollow shaft into the screen (14). A separate inner sieve (40), also of cylindrical or frusto-conical form, is mounted to the second shaft (30) and serves either as a trash trap, or to provide a second product split by size with coarse particles which have passed through the sieve (40) but not the screen (14) exiting through outlet (18).

### TECHNICAL FIELD

The present invention relates to centrifugal sifting apparatus as used for separation of particles according to size in a wide range of industries, such as food processing, fine chemicals, pharmaceuticals, dyes and pigments, powder coatings and many others. While the invention is described with respect to separation of solid from solid, the principle is equally applicable to separation of solid from liquid.

### BACKGROUND ART

A conventional centrifugal sifting machine has a stationary cylindrical screen, often referred to as a sifting basket, arranged inside a machine housing with a rotatable paddle assembly mounted inside the cylindrical screen. Material to be separated is introduced into the screen in an axial direction by an auger screw, also arranged inside the housing, which typically terminates at the inlet of the screen assembly, but may project into one end of the screen enclosure. During operation, material to be separated usually enters the auger screw section of the housing from above by way of a product inlet section. The auger screw is a helically extending blade which conveys the material into the screen where it is picked up by the rotating paddle assembly and thrown centrifugally against the screen. Blades of the paddle assembly are typically, but not always, tilted slightly relative to the axial direction, in what is termed a slow helix disposition, so that they convey the material axially inside the screen as well as around the circumference as the paddle rotates. Particles below the aperture size of the screen are expelled through the screen by the large centrifugal forces exerted as a result of rotation of the paddle assembly and fall as sifted product into an outlet hopper. Larger particles above the screen perforation size gradually progress along the screen to be discharged at the end remote from the auger into a course product outlet.

Centrifugal sifting by means of a rotary paddle assembly within a cylindrical screen is an extremely effective means of sieving particulate material because of the potential high loading of product per unit of screen area, namely the high throughout as well as the possibility of continuous operation.

In conventional centrifugal sifting machines both the auger screw and the paddle assembly are mounted on a common shaft which is mounted in the housing by way of respective bearings, one at each end of the housing. However, in some known machines the complete shaft assembly is supported in a cantilever manner via a rigid bearing arrangement, usually at the drive end. This common shaft is rotated by a single drive motor, typically located outside the housing at the end of the housing adjacent the auger screw.

In some sifting applications it is desirable to provide a so-called “trash trap”, namely a device to prevent contaminant materials, typically of larger size than either the particle size of the sifted product which passes through the screen, or the course product which does not pass through the screen, from damaging the screen and/or the paddles. In some known machines this has been proposed by using a cage which is either statically mounted inside the paddle assembly, or is mounted to the shaft which carries the paddle assembly, thus rotating in unison with the paddle assembly.

In some sifting applications it may be desirable to provide two grades of sifted product, namely two streams with different maximum particle size.

The present invention aims to provide a configuration of apparatus which enables both possibilities.

### SUMMARY OF THE INVENTION

The present invention provides centrifugal sifting apparatus comprising a machine housing having an upstream end section and a downstream end section; a stationary screen of cylindrical or frusto-conical form mounted inside the housing in the downstream end section; an auger screw provided in the upstream end section on a shaft which is rotatable to feed material to be sifted into an end of the screen, said first shaft being mounted in cantilever manner from the upstream end of the housing, and drive means mounted at or near the upstream end of the housing and operable to rotate the first shaft; and a paddle assembly provided in the downstream end section, inside the screen, and mounted to the same shaft as the auger screw. Compared to previously known centrifugal sifting apparatus, in the present invention the shaft on which the auger screw and paddle assembly are mounted is a first hollow shaft and a second rotatable shaft is provided, extending through the first hollow shaft and projecting beyond the first hollow shaft into the screen, and a separate inner sieve, also of cylindrical or frusto-conical form, is mounted to the second shaft to rotates in unison there with.

Thus, the additional inner sieve either provides the trash trap or it provides means of deriving a second product split, namely a product of larger particle size than that provided for by the stationary screen. Because the additional inner sieve is rotated in use, independently of the paddle assembly, it allows for the possibility of a second product split as the rotation facilitates movement of product longitudinally through the sifting section of the machine. Alternatively, where the additional inner sieve is used to provide a trash trap, this is more efficient than previously in moving such contaminant materials through the machine for discharge, as the rotational speed of the inner sleeve can be independently adjusted to better suit the weight, size and type of contaminant, whereas previously it may have remained in the machine for a period of time during its operation and suffered potential degradation within the machine.

As noted, the inner sieve may be either of cylindrical form, or it may be of a frusto-conical form, either tapering in diameter from the upstream towards the downstream end of the machine, or increasing in diameter from the upstream towards the downstream end of the machine. An appropriate frusto-conical configuration may be chosen to facilitate control of the speed of passage of material being sifted through the machine from the feed section to the downstream discharge outlet or outlets.

In order to further facilitate such movement of material through the sifting section of the apparatus from the upstream to the downstream end, the inner sieve may be provided with blades or baffles on its interior surface.

Additionally or alternatively, stationary blades may be mounted in cantilever manner at or adjacent the downstream end of the housing and extend longitudinally of the housing so as to project inside the sieve. Such blades may additionally serve to disperse any agglomerated material, thus improving efficiency and yield of sifted product by the apparatus.

The speed of rotation of the respective shafts may be independently controlled. This may be by providing each shaft with its own separate drive motor. However, with the present invention the possibility is provided of using only a single drive motor to power rotation of both shafts, but having separate transmissions to the respective shafts, thus a possibility of different gearing and different shaft rotation speeds.

### BRIEF DESCRIPTION OF THE DRAWINGS

The invention will be described further, by way of example, by reference to the accompanying drawings, in which:

FIG. 1 is a fragmentary, schematic longitudinal cross-section through a practical embodiment of sifting apparatus in accordance with the present invention; and

FIG. 2 is an enlarged detail of part of FIG. 1 in the vicinity of the connection between the feed section and the sifting section of the apparatus.

### DETAILED DESCRIPTION

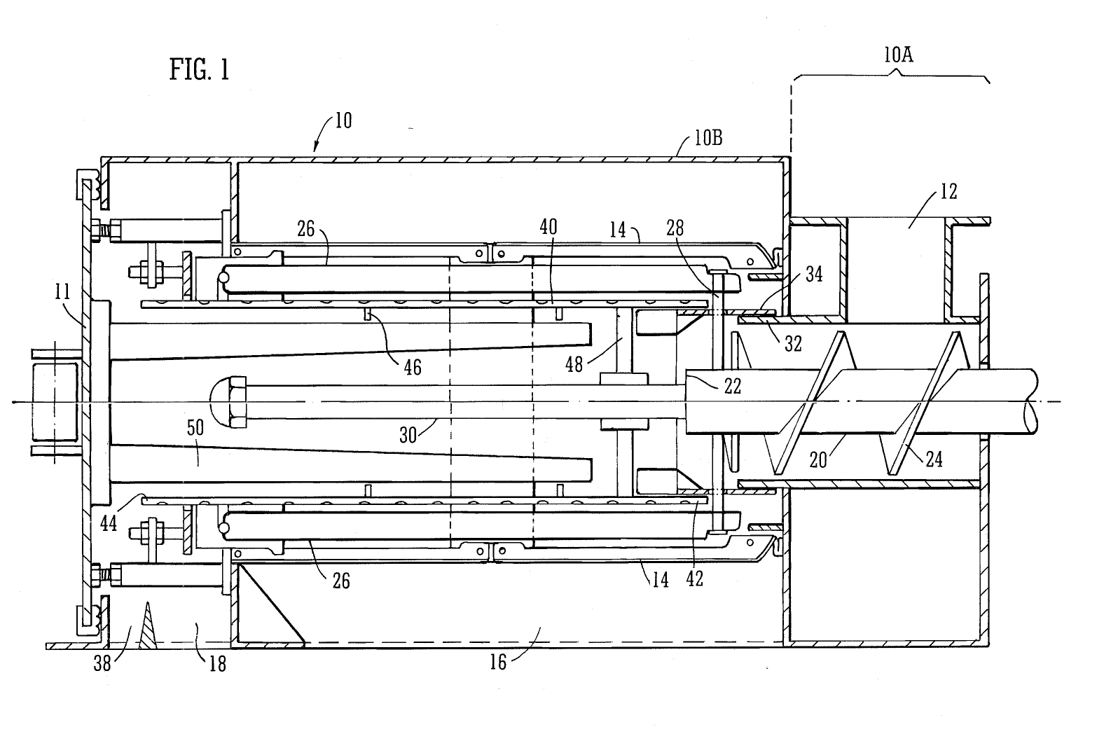

As shown in FIG. 1, a machine housing 10 is divided into a feed section 10A at the right side and a sifting section 10B at the left side. A product inlet 12 is arranged in an upper wall of the feed section 10A. A stationary cylindrical screen 14 is mounted in the sifting section 10B and below this is a fines outlet 16 for material which has passed through the screen 14 discharging into a sifted product hopper or other means of collection or removal from the outlet (not shown). Beyond the end of the screen 14, remote from the feed section 10A, a course product outlet 18 and next to that an oversize/waste product outlet 38 are provided in the bottom of the housing. These outlets 18, 38 are for particles which have not passed through the screen 14.

A bearing housing and a transmission housing (not shown) are mounted to the right of the feed section 10A. A hollow shaft 20 is mounted by means of bearing assemblies (not shown) in that bearing housing in any conventional manner. This hollow shaft 20 extends from the bearing housing and through the feed section 10A to a second end 22 which lies a short distance into the sifting section 10B of the housing 10. Thus, this shaft 20 is mounted in cantilever manner. The portion of the shaft 20 which lies in the feed section 10A and extends into the sifting section 10B the shaft 20 carries a helical blade 24 providing an auger screw for feed of product to be sifted towards the sifting section 10B upon rotation of the hollow shaft 20.

In the sifting section 10B a paddle assembly 26 is mounted onto the shaft 20. This paddle assembly 26 is mounted from adjacent the free end 22 of the shaft 20 by means of radial connectors 28 and extends in cantilever manner into the sifting section 10B. The paddle assembly 26 is of any known or yet to be devised configuration and fits within the cylindrical screen 14 with suitable circumferential clearance. Upon rotation of the shaft 20, the paddle assembly 26 effects centrifugal sifting of product fed in from the feed section 10A in conventional manner by throwing the material tangentially and radially at the screen 14 while also conveying material axially towards the outlets 18, 38. The housing wall of the sifting section 10B, adjacent the feed section 10A, is provided with a short spigot 32 which protrudes a short distance into the sifting section 10B and directs product to be sifted from the auger 24 further into the sifting section 10B before it discharges. The paddle assembly 26 has a support arrangement which, in addition to the radial connectors 28, includes a short tube 34 of sufficient diameter to slide over spigot 32 with a small running clearance between them such that the tube 34 picks up and transports product discharged from the spigot 32 and transports it further into the sifting section 10B.

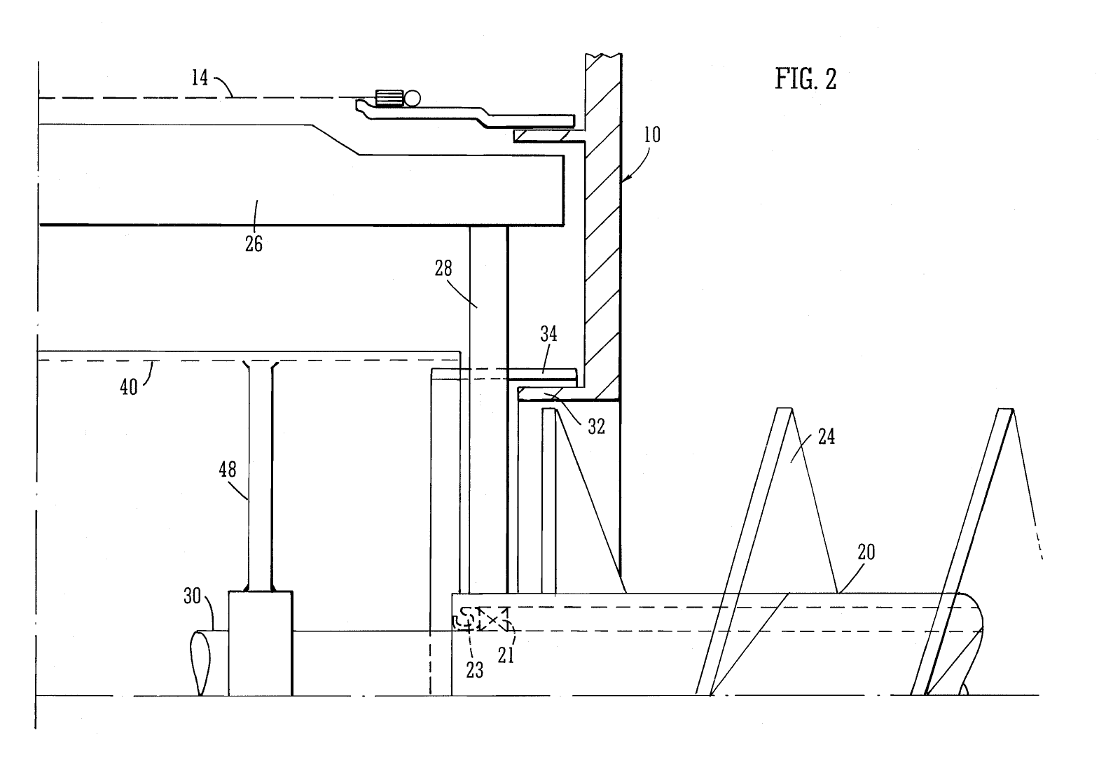

Respective bearings are provided in the interior of the hollow shaft 20, only a bearing 21 adjacent the free end 22 of the shaft 20 and an associated lip seal 23 being shown in FIG. 2 of the drawings. In other embodiments, other arrangements of bearing and protective seal combinations are possible, including the use of purge air or gas. A further longer shaft 30 is mounted by these bearings to extend co-axially through the hollow shaft 20 and project out of the free end 22 of the shaft 20. This shaft 30 is also mounted in cantilever fashion and projects through a substantial portion of the sifting section 10B.

A cylindrical sieve 40 is mounted onto the inner shaft 30 by means of radial connectors 48 and rotates in unison with the inner shaft 30. A first end 42 of the cylindrical sieve 40, in the vicinity of the hollow shaft 20, is designed by choice of appropriate diameter to overlap a portion of the tube 34 and slide over it with a small running clearance between them such that product discharged from the tube 34 falls directly into the cylindrical sieve 40. An opposing end 44 of the cylindrical sieve 40, in the vicinity of an endplate 11 of the sifting section housing 10, extends a short distance beyond the end of the paddle assembly 26 and the surrounding stationary screen 14. The protruding end portion of the sieve 40 thereby overlies the course product outlet 18.

The mesh size or screen aperture size of the sieve 40 is larger than the mesh size/screen aperture size of the stationary screen 14.

In use of the apparatus, product discharged from the auger 24 into the rotating cylindrical sieve 40 will be picked up and distributed around the inner surface of the sieve 40 and a size separation will take place whereby particles smaller than the screen aperture size of the sieve 40 pass through into the main sifting chamber while particles which are larger than the aperture size of the sieve 40 will progress axially along the cylindrical sieve 40 until they reach the other end of the sieve 40 and are discharged to the oversize/waste particle outlet 38. To promote or regulate axial progression of product along the interior of the cylindrical sieve 14, the latter may be provided, as shown, with blades or baffles 46 fixed at intervals along its interior surface.

An additional or alternative manner of regulating axial flow of product along the sifting section 10B is the optional provision of one or more static blades 50 supported from the housing endplate 11 and extending axially down the inside of the cylindrical sieve 40. This blade or these blades will disrupt distribution of product inside the cylindrical sieve 40, preventing agglomeration and ensuring that it does not line the inner surface of the sieve 40.

Product particles smaller than the aperture size of the sleeve 40 will either pass through the stationary screen 14, because they are also smaller than its aperture size, or they will be conveyed axially by the paddle assembly 26 to be discharged from the end of the screen 14, outside the protruding end portion of the sieve 40, into the course particle outlet 18. In this way, it is possible to achieve two product splits instead of one, obtaining a fine product via the outlet 16, a course product via the outlet 18 and oversize product or debris/tramp material which might otherwise damage the paddle assembly via the outlet 38. However, depending upon the application, a single product split may be all that is required, with product discharged from the cylindrical sieve 40 being joined with that from the outer screen 14 as one stream in a common course/oversize product outlet, i.e. outlets 18, 38, conjoined.

Drive means (not shown) for rotation of the respective shafts 20, 30 are provided at the same end of the apparatus, namely the right hand end in FIG. 1.

The shafts 20, 30 may be driven (rotated) completely independently of each other by means of two separate motors (not shown) with respective transmission belts and gearing. Thus, not only can the speed of rotation of each shaft 20, 30 be independently controlled, but they can also be rotated in opposing directions. In other embodiments a single motor may provide power for rotation of both of the shafts, their respective rotation rates having potential to be set differentially by use of separate transmission and separate gearing fed from the same motor drive shaft.

A primary advantage of these designs where both shaft drive means, i.e. motors, are provided at the upstream end of the apparatus, adjacent the feed section 10A, and both shafts 20, 30 are mounted in cantilever manner is that the inner shaft can be used to mount a rotatable inner cylindrical sieve which is more efficient than previously provided stationary trash traps in sifting apparatus. A further advantage of this design is that a simple, removable closure plate 11 is all that is needed at the end of the sifting section 10B. The end closure 11 does not incorporate and is not associated with any bearing means for mounting a shaft, nor any means for mounting a drive mechanism for said shaft. Therefore the opening and closing of the end closure plate 11 is particularly easy to accomplish, facilitating necessary cleaning of the cylindrical screen 14 and the sifting section 10B and access for maintenance. Further, there is no requirement for clearance to allow drive means to be displaced to allow access, nor any need to move a heavy drive assembly upon opening and closing the end of the sifting section 10B.

The foregoing is illustrative not limitative of the scope of the invention and variations in details of design of the apparatus are possible in other embodiments.

In other embodiments the inner shaft may not be mounted in cantilever fashion and could be mounted in journal bearings at each end. In yet other embodiments the inner shaft may not be coaxial with the hollow shaft, through which it extends, i.e. it may not have a common axis. Instead, the inner shaft may have a different axis, probably substantially parallel to the axis of the hollow shaft through which it extends.

Also, in other embodiments, the stationary screen may be of frusto-conical form instead of cylindrical form and in that case it may increase or decrease in diameter from upstream to downstream end of the machine. Similarly, the sieve which is mounted inside the screen onto the inner rotatable shaft of the apparatus may be of frusto-conical form instead of cylindrical form, also either increasing or decreasing in diameter from upstream to downstream end of the machine whichever is appropriate to best meet the specific requirements for the sifting operation to be achieved in the apparatus.

As mentioned at the beginning, while the invention and the specific embodiment have been described with respect to separation of solid from solid, apparatus having the same features could be adapted to separate solids from liquids, namely starting with a slurry from which lumps need to be removed or a liquid from which solid particles need to be removed.

1. Centrifugal sifting apparatus comprising:
a machine housing having an upstream end section and a downstream end section;
a stationary screen of cylindrical or frusto-conical form mounted inside the housing in the downstream end section;
an auger screw provided in the upstream end section on a shaft which is rotatable to feed material to be sifted into an end of the screen, said first shaft being mounted in cantilever manner from the upstream end of the housing, and drive means mounted at or near the upstream end of the housing and operable to rotate the first shaft; and
a paddle assembly provided in the downstream end section, inside the screen, and mounted to the same shaft as the auger screw;
wherein the shaft on which the auger screw and paddle assembly are mounted is a first hollow shaft and a second rotatable shaft is provided, extending through the first hollow shaft and projecting beyond the first hollow shaft into the screen, and a separate inner sieve, also of cylindrical or frusto-conical form, is mounted to the second shaft.

2. Apparatus as set forth in claim 1 wherein the second shaft extends co-axially through the hollow first shaft.

3. Apparatus as set forth in claim 1 wherein the second shaft also extends in cantilever manner, through the hollow first shaft, from the upstream end of the housing.

4. Apparatus as set forth in claim 3 wherein drive means operable to rotate the second shaft is also provided at the upstream end of the housing.

5. Apparatus as set forth in claim 4 wherein the drive means operable to rotate the first shaft and to rotate the second shaft comprises a single motor as drive actuator, but respective transmission means for each of the first and second shafts.

6. Apparatus as set forth in claim 1 wherein the drive means operable to rotate the first shaft and drive means to rotate the second shaft comprise a separate motor and transmission means for each of the first and second shafts.

7. Apparatus as set forth in claim 1 wherein a closure plate having neither bearing nor shaft mounting function is provided at the downstream end of the housing and/or the screen, remote from the auger screw, said closure plate being openable for access to the screen.

8. Apparatus as set forth in claim 1 wherein the second shaft extends through the hollow first shaft from the upstream end of the housing to the downstream end of the housing and the second shaft is rotatably supported at the upstream end and at the downstream end of the housing.

9. Apparatus as set forth in claim 1 wherein stationary blades are mounted in cantilever manner at or adjacent the downstream end of the housing and said blades extend longitudinally of the housing and project inside the sieve.

10. Apparatus as set forth in claim 1 wherein the sieve is provided with blades or baffles on its interior surface.

11. Apparatus as set forth in claim 1 wherein three outlets are provided in the downstream end section of the housing, namely a first outlet for discharging material which has passed through the stationary screen, a second outlet for discharging material which has passed through only the inner sieve, and a third outlet for oversize material.
